(19) United States
(12) Patent Application Publication
(10) Pub. No.: US 2017/0109128 A1
(43) Pub. Date: Apr. 20, 2017

(54) Continuous Audio-Clip Streaming with Dynamic Content

(71) Applicant: Clammr, Inc., Cambridge, MA (US)

(72) Inventors: Parviz Parvizi, Cambridge, MA (US); David H. Silverman, Los Angeles, CA (US)

(73) Assignee: Clammr, Inc., Cambridge, MA (US)

(21) Appl. No.: 15/297,117

(22) Filed: Oct. 18, 2016

Related U.S. Application Data
(60) Provisional application No. 62/243,220, filed on Oct. 19, 2015.

(51) Int. Cl. G06F 3/16; G06F 3/0481

(52) U.S. Cl. CPC G06F 3/165; G06F 3/0481

(57) ABSTRACT

An electronic device provides a temporal stream of audio clips on an ongoing basis. In particular, the temporal stream of audio clips includes a sequence of temporal subsets of audio content for the audio clips. For example, a temporal subset of the audio content for a given audio clip may include a snippet of the audio content that has a time duration that is a fraction of a time duration of the audio content. In response to a user selection of a particular audio clip, the temporal stream of audio clips is temporarily suspended while at least a remainder of the audio content for the particular audio clip is provided to the user. Moreover, when the temporal stream of audio clips resumes, it may be dynamically modified based on the user selection, one or more previous user selections and/or user selections made by other users.

### CROSS-REFERENCE TO RELATED APPLICATION

The is application claims priority under 35 U.S.C. §119(e) to: U.S. Provisional Application Ser. No. 62/243,220, entitled “Continuous Audio-Clip Streaming with Dynamic Content,” by Parviz Parvizi, Attorney Docket Number CLMR-1501, filed on Oct. 19, 2015, the contents of which are herein incorporated by reference.

### BACKGROUND

Field

The described embodiments relate to techniques for providing content, including providing a continuous temporal stream of audio clips with dynamic content based on user selections.

Related Art

The popularity of the Internet has resulted in an ever-increasing amount of content that is available to individuals. Finding content that is of interest in this large pool of content can be daunting. In principle, search engines are powerful tools that can allow individuals to identify and access content that is of interest to them even in the enormous amount of content that is available online.

However, in practice a search engine typically requires an individual to know something about the content they are interested in, so that the individual can specify a search query (including one or more keywords) that is used by the search engine to identify content that is potentially of interest. In the absence of such a priori knowledge, an individual usually cannot leverage the power of a search engine to identify content that is of interest to them.

Moreover, even when an individual knows, in general, a topic or a class of content that is of interest to them, this still may not be sufficient for a search engine to identify the best content for them. For example, many search engines identify content based on a ranking, such as based on match scores that indicate how well terms in a search expression (which is based on a search query provided by an individual) match the content in different documents in a corpus of documents. However, if there are a large number of documents with very similar match scores, there may be too many options for the individual to identify the content that is of interest to them.

Similarly, the corpus of documents used by the search engine is typically updated at a finite frequency. Consequently, when content is changing rapidly, the content identified by the search engine may not be relevant or ‘fresh’ to the individual.

Hence, what is needed is a technique for individuals to identify and access content that is of interest to them without the problems described above.

### SUMMARY

The described embodiments relate to an electronic device that provides a temporal stream of audio clips. This electronic device includes: an interface circuit, a processor and memory that stores a program module. During operation, the interface circuit communicates with another electronic device, and the processor executes the program module to perform operations. In particular, the electronic device receives an activation command from the other electronic device associated with a user. Then, the electronic device generates, on an ongoing basis until one of information specifying a user selection and a deactivation command is received, the temporal stream of audio clips, where a given audio clip includes a given temporal subset of audio content that is associated with the given audio clip, and the audio clips are arranged sequentially in the temporal stream. Moreover, the electronic device provides, on the ongoing basis, the audio clips in the temporal stream of audio clips to the other electronic device.

Subsequently, the electronic device receives, from the other electronic device, the information specifying the user selection of one of the audio clips. In response to the user selection, the electronic device suspends the providing, to the other electronic device, of the temporal stream of audio clips. Next, the electronic device provides, to the other electronic device, audio content associated with the one of the audio clips, where the audio content includes at least a second temporal subset of the audio content that is longer than a first temporal subset in the one of the audio clips, and the first temporal subset and the second temporal subset have approximately the same audio quality (such as the same sampling rate). Furthermore, the electronic device resumes the providing, to the other electronic device, of the audio clips in the temporal stream of audio clips when the audio content is completed.

Note that the temporal stream of audio clips may resume at a timestamp when the user selection was made. Alternatively, the temporal stream of audio clips may resume at a beginning of a subsequent audio clip in the temporal stream of audio clips after the one of the audio clips.

In some embodiments, the electronic device provides, concurrently with the audio content, video content associated with the one of the audio clips to the other electronic device.

Moreover, prior to resuming the providing of the temporal stream of audio clips, the electronic device may dynamically adapt the generation of the temporal stream of audio clips based on the user selection to modify subsequent audio clips in the temporal stream of audio clips. Furthermore, the generation of the temporal stream of audio clips may be dynamically adapted based on a user-selection history of the user (which includes one or more user selections prior to the user selection) and/or user selections made by other users.

Additionally, the first temporal subset may include a snippet of the audio content that has a time duration that is a fraction of a time duration of the audio content.

In some embodiments, the memory stores predefined user preferences of the user, and the electronic device generates the temporal stream of audio clips based on the predefined user preferences.

Another embodiment provides a computer-program product for use with the electronic device. This computer-program product includes instructions for at least some of the operations performed by the electronic device.

Another embodiment provides a method for providing the temporal stream of audio clips.

Another embodiment provides the other electronic device.

Another embodiment provides another computer-program product for use with the other electronic device. This other computer-program product includes instructions for at least some of the operations performed by the other electronic device.

Another embodiment provides a method for receiving the temporal stream of audio clips.

The preceding summary is provided as an overview of some exemplary embodiments and to provide a basic understanding of aspects of the subject matter described herein. Accordingly, the above-described features are merely examples and should not be construed as narrowing the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices communicating in accordance with an embodiment of the present disclosure.

FIG. 2 is a flow diagram illustrating a method for providing a temporal stream of audio clips during communication of the electronic devices in FIG. 1 in accordance with an embodiment of the present disclosure.

FIG. 3 is a flow diagram illustrating a method for receiving the temporal stream of audio clips during communication of the electronic devices in FIG. 1 in accordance with an embodiment of the present disclosure.

FIG. 4 is a drawing illustrating communication among the electronic devices in FIG. 1 in accordance with an embodiment of the present disclosure.

FIG. 5 is a drawing illustrating a temporal stream of audio clips in accordance with an embodiment of the present disclosure.

FIG. 6 is a drawing illustrating a temporal stream of audio clips in accordance with an embodiment of the present disclosure.

FIG. 7 is a block diagram illustrating one of the electronic devices of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to allow a user to sort through a large quantity of content to identify and access content that is of interest to the user, an electronic device provides a temporal stream of audio clips on an ongoing basis. In particular, the temporal stream of audio clips includes a sequence of temporal subsets of audio content for the audio clips. For example, a temporal subset of the audio content for a given audio clip may include a snippet of the audio content that has a time duration that is a fraction of a time duration of the audio content (thus, the audio clips are sometimes referred to as ‘short-form audio clips’). In response to a user selection of a particular audio clip, the temporal stream of audio clips is temporarily suspended while at least a remainder of the audio content for the particular audio clip is provided to the user. Moreover, when the temporal stream of audio clips resumes, it may be dynamically modified based on the user selection, one or more previous user selections and/or user selections made by other users.

By providing the temporal stream of audio clips, this content-presentation technique may allow the user to efficiently screen a large amount of content (such as audio content, as well as associated video content). This approach may allow the user to identify content that is of interest, even when it may be difficult, a priori, to determine which audio clips are likely to be of interest (e.g., when the user does not know what type of content they are looking for or when the content appears to be similar to each other). In addition, the content-presentation technique may allow the user to identify and access content that is very recent (and, thus, may not have been included in a corpus of documents used by a search engine). Consequently, the content-presentation technique may allow the user to identify and access valuable or useful content, which may enhance the overall user experience.

In the discussion that follows, an individual or a user may be a person. Also, or instead, the content-presentation technique may be used by any type of organization, such as a business, which should be understood to include for-profit corporations, non-profit corporations, groups (or cohorts) of individuals, sole proprietorships, government agencies, partnerships, etc.

Moreover, in the discussion that follows, electronic devices may communicate using a wide variety of communication protocols. For example, the communication may involve wired or wireless communication. Consequently, the communication protocols may include: an Institute of Electrical and Electronics Engineers (IEEE) 802.11 standard (which is sometimes referred to as ‘Wi-Fi®,’ from the Wi-Fi Alliance of Austin, Tex.), Bluetooth® (from the Bluetooth Special Interest Group of Kirkland, Wash.), another type of wireless interface (such as another wireless-local-area-network interface), a cellular-telephone communication protocol (e.g., a 3G/4G communication protocol, such as UMTS, LTE), an IEEE 802.3 standard (which is sometimes referred to as ‘Ethernet’), etc. In the discussion that follows, Ethernet and Wi-Fi are used as illustrative examples.

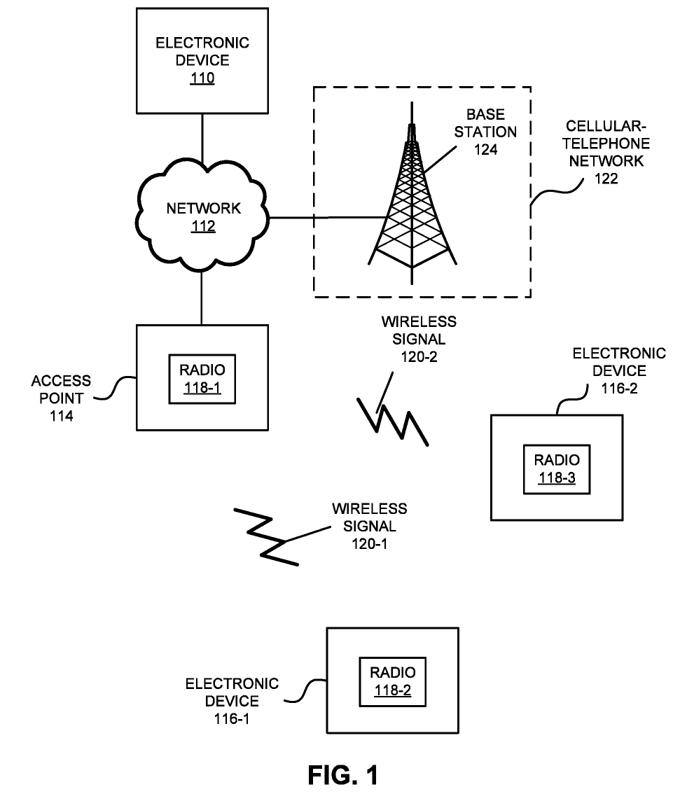

Communication among electronic devices is shown in FIG. 1, which presents a block diagram illustrating electronic device 110 (such as a server or a computer system) communicating with one or more electronic devices 116 (such as portable electronic devices, e.g., cellular telephones) via network 112 (such as the Internet) and access point 114. In particular, electronic device 110 may communicate with access point 114 via Ethernet. Then, access point 114 may wirelessly communicate with one of electronic devices 116, such as electronic device 116-1. (Alternatively or additionally, electronic device 110 may communicate with electronic devices via a cellular-telephone network 122, including one or more base stations, such as base station 124.) The wireless communication may include: transmitting advertising frames on wireless channels, detecting one another by scanning wireless channels, establishing connections (for example, by transmitting association requests), and/or transmitting and receiving packets (which may include the association requests and/or additional information, such as a temporal stream of audio clips, as payloads).

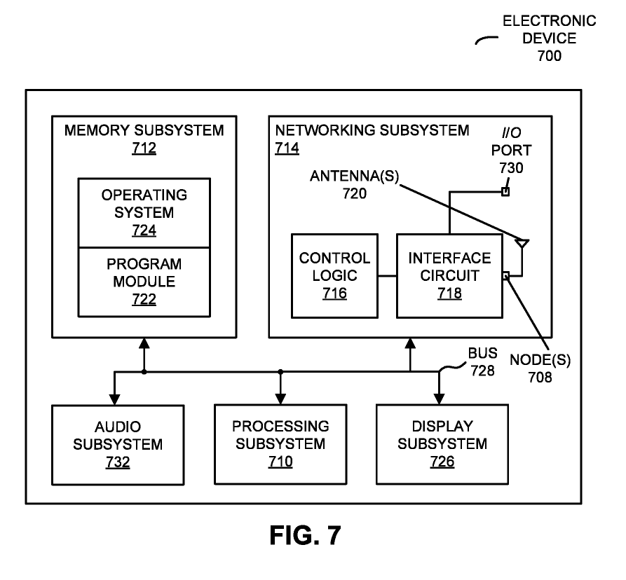

As described further below with reference to FIG. 7, electronic device 110, access point 114 and electronic device 116 may include subsystems, such as a networking subsystem, a memory subsystem and a processor subsystem. In addition, access point 114 and electronic devices 116 may include radios 118 in the networking subsystems. More generally, electronic devices 116 can include (or can be included within) any electronic devices with the networking subsystems that enable electronic devices 116 to wirelessly communicate with each other and/or access point 114. The wireless communication can comprise transmitting advertisements on wireless channels to enable access point 114 and electronic device 116 to make initial contact or detect each other, followed by exchanging subsequent data/management frames (such as association requests and responses) to establish a connection, configure security options (e.g., Internet Protocol Security), transmit and receive packets or frames via the connection, etc.

Moreover, as can be seen in FIG. 1, wireless signals 120 (represented by jagged lines) are transmitted by radios 118 in access point 114 and electronic devices 116. For example, radio 118-1 in access point 114 may transmit information (such as packets) using wireless signals. These wireless signals are received by radios 118 in one or more of electronic devices 116 (such as electronic device 116-1). This may allow access point 114 to communicate information to electronic device 116-1.

In the described embodiments, processing a packet or frame in access point 114 and electronic devices 116 includes: receiving the wireless signals with the packet or frame; decoding/extracting the packet or frame from the received wireless signals to acquire the packet or frame; and processing the packet or frame to determine information contained in the packet or frame (such as an activation command, a temporal stream of audio clips, information specifying a user selection, a deactivation command, etc.).

Note that the communication among access point 114 and electronic devices 116 (such as between at least any two of electronic devices 116 and access point 114) may be characterized by one or more of a variety of performance metrics, such as: a received signal strength indication (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

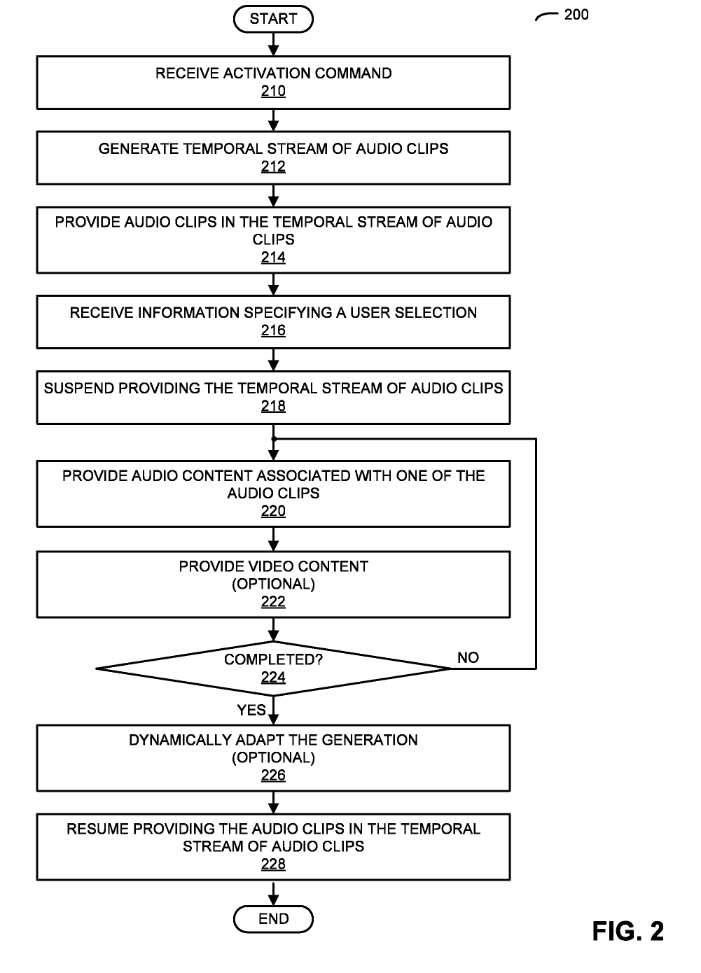

As described previously, it may be difficult for individuals to sort through large amounts of content to identify and then access content that is of interest to them. Moreover, as described further below with reference to FIG. 2, in order to address this problem electronic device 110 may provide one or more temporal stream of audio clips (with sound, speech, singing, music, sound effects and, more generally, information in a range of frequencies that can be heard by humans, which, therefore, is more than just metadata characterizing the audio clips) to corresponding electronic devices 116. In particular, a given temporal stream of audio clips may be provided to a given electronic device (such as electronic device 116-1). For example, a user of electronic device 116-1 may subscribe to a service provided by electronic device 110. (However, in other embodiments the user does not need to enroll or subscribe to the service in advance.) During an enrollment process, the user may specify information about themselves, topics that are of interest, etc. Alternatively or additionally, the user may provide credentials (such as a username and password) for a social network (or an online forum). Then, electronic device 110 may use the credentials to access the social network to obtain a history of user activities or user behaviors when using the social network. In some embodiments, an identifier of electronic device 116-1 is used to identify the user and, thus, to specify the information about the user.

Collectively, the information directly or indirectly provided by the user may be used by electronic device 110 to create a user profile with information specifying user interests. For example, a user profile may include: demographic information (such as age and gender), contact information, geographic location, work industry for a current employer, a department (e.g., engineering, sales, consulting), seniority in an organization, employer size, education (such as schools attended and degrees earned), employment history (such as previous employers and the current employer), professional development, interests (such as topics that are of interest), groups that the user is affiliated with or that the user tracks or follows, a job title, additional personal or professional attributes, properties or characteristics (such as skills), and/or inferred attributes, properties or characteristics (which may include or be based on user behaviors). Moreover, the user behaviors may include: search frequencies, search topics, browsing certain web pages, locations (such as IP addresses) associated with the users, advertising or recommendations presented to the users, user responses to the advertising or recommendations, likes or shares exchanged by the users, interest segments for the likes or shares, documents viewed or posted by the user, the number of views or postings, the frequency of viewing or posting, messages transmitted or received, etc.

The service may, at least in part, be provided using instances of a software application that is resident on and that executes on electronic devices 116. In some implementations, the user may interact with a web page that is provided by electronic device 110 via network 112 and access point 114, and which is rendered by a web browser on electronic device 116-1. For example, at least a portion of the software application executing on electronic device 116-1 may be an application tool that is embedded in the web page, and that executes in a virtual environment of the web browser. Thus, the application tool may be provided to the user via a client-server architecture.

Note that the software application operated by the user may be a standalone application or a portion of another application that is resident on and that executes on electronic device 116-1 (such as a software application that is provided by electronic device 110 or that is installed on and that executes on electronic device 116-1).

While using electronic device 116-1, the user may use the software application to indicate that they would like electronic device 110 to provide a temporal stream of audio clips. For example, the use may activate a virtual icon in a user interface displayed on a touch-sensitive display in electronic device 116-1, such as by contacting a surface of the touch-sensitive display with a strike area associated with the virtual icon and/or by applying a pressure or a force exceeding a threshold value to the surface of the touch-sensitive display. Alternatively or additionally, the user may activate a physical button, scroll wheel or switch in electronic device 116-1. Furthermore, the user may verbally provide commands to the software application, which are then identified using a voice-recognition technique. (However, in some embodiments the temporal stream of audio clips is initiated at a predefined time, which was previously specified or scheduled by the user.) In response to this user action, electronic device 116-1 may provide an activation command to electronic device 110.

When electronic device 110 receives the activation command from electronic device 116-1, electronic device 110 (such as a content engine or a program module) may generate, on an ongoing basis until information specifying a user selection or a deactivation command is received, a temporal stream of audio clips. In some embodiments, the temporal stream of audio clips is optionally generated based on the user profile, including the predefined or predetermined user preferences. Alternatively or additionally, the temporal stream of audio clips may be optionally generated based on: a user-specified play list (such as a string of audio clips that are presented together sequentially); a geographic location of the user (or electronic device 116-1), such as geo-tagged playlist of audio clips for a particular location; how long ago the audio clips were previously played; popularity of the audio clips within a social circle of the user (or user's with similar characteristics, attributes and/or user profiles); a predefined channel that includes multiple audio clips from one or more sources (and which may have been specified by the user); audio clips specified by the user; and/or audio clips previously presented to the user (which may be excluded).

Note that a given audio clip may include a given temporal subset of audio content that is associated with the given audio clip, and the audio clips may be arranged sequentially in the temporal stream. For example, the given temporal subset may include a snippet of the audio content (or a highlight or a preview of the audio content) that has a time duration that is a fraction of a total time duration of the audio content. In particular, the snippet may include the first 5 or 10 s (or 5 or 10 s that may be interest) in the audio content, which may have a total time duration of 30 s or one or more minutes. (Thus, the temporal stream of audio clips may be a sequential series of short teasers for different audio content that may be of interest to the user. For example, the audio clips may be for a particular topic, such as real estate, or may be associated with a variety of different topics, such as a type of news broadcast.) This snippet may have approximately the same audio quality as the audio content (e.g., the same or approximately the same sampling rate or sampling frequency). Note that the audio clips in the temporal stream of audio clips may be generated on the fly or in real-time as the temporal stream of audio clips is generated, or the audio clips in the temporal stream of audio clips may be predetermined and stored in memory in electronic device 116-1 for use when generating the temporal stream of audio clips.

Then, electronic device 110 may provide, on the ongoing basis, the audio clips in the temporal stream of audio clips to electronic device 116-1, and electronic device 116-1 may present the temporal stream of audio clips to the user. For example, electronic device 116-1 may output sound associated with the audio clips on one or more speakers or may output electrical signals on a headphone jack or output port. Note that the volume may be normalized or constant from the end of one audio clip to the beginning of the next audio clip (e.g., it may be averaged or filtered). Alternatively, the volume may be the same for all of the audio clips.

While listening to one of the audio clips, the user may hear something that is of interest. When this occurs, the user may activate a virtual icon in the user interface on electronic device 116-1 or may activate a physical button, scroll wheel or switch in electronic device 116-1. In response to this user action, electronic device 116-1 may provide information specifying this user selection to electronic device 110.

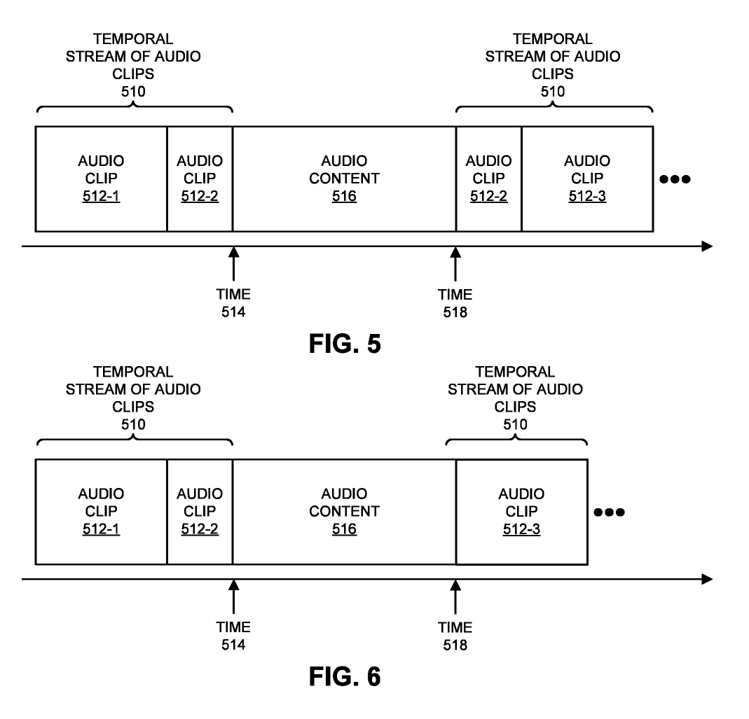

When electronic device 110 receives the information specifying the user selection of one of the audio clips, electronic device 110 may suspend or stop providing the temporal stream of audio clips to electronic device 116-1. Instead, as described further below with reference to FIGS. 5 and 6, electronic device 110 may provide, to electronic device 116-1, audio content associated with the one of the audio clips. This audio content may include at least a temporal subset of the audio content that is longer than the temporal subset for the one of the audio clips that was included in the temporal stream of audio clips. For example, the longer temporal subset of the audio content may include at least a remainder of the audio content (i.e., it may commence or start at timestamp when the user selection was made). Alternatively, the longer temporal subset of the audio content may start from the beginning of the audio content, such that the entire or total time duration of the audio content may be provided to electronic device 116-1.

Moreover, when electronic device 116-1 receives the longer temporal subset of the audio content, it may present it to the user. For example, electronic device 116-1 may output sound associated with the longer temporal subset of the audio content on the one or more speakers or may output electrical signals on the headphone jack or output port.

In some embodiments, electronic device 110 provides, concurrently with the audio content, video content associated with the one of the audio clips to electronic device 116-1. Furthermore, electronic device 116-1 may present the video content to the user, e.g., on a display in electronic device 116-1.

Once the longer temporal subset of the audio content is finished or completed, electronic device 110 may resume providing, to electronic device 116-1, the audio clips in the temporal stream of audio clips, which are presented to the user by electronic device 116-1. Note that the temporal stream of audio clips may resume at: the timestamp when the user selection was made (i.e., in or during the one of the audio clips); or a beginning of a subsequent audio clip in the temporal stream of audio clips after the one of the audio clips (such as at the beginning of the next audio clip).

In some embodiments, prior to resuming the providing of the temporal stream of audio clips, electronic device 110 dynamically adapts the generation of the temporal stream of audio clips to modify subsequent audio clips in the temporal stream of audio clips. For example, the temporal stream of audio clips may be dynamically adapted or modified based on the user selection of the one of the audio clips. Thus, if the user selects a particular audio clip associated with a topic, subsequent audio clips in the temporal stream of audio clips may be associated with the topic or a class of topics that includes the topic. In particular, if the user selections an audio clip of a realtor tour of a house in a particular neighborhood, subsequent audio clips in the temporal stream of audio clips may be for realtor tours of houses in the same neighborhood and/or adjacent neighborhoods. Alternatively or additionally, other attributes or characteristics of the selected one of the audio clips may be used to modify subsequent audio clips in the temporal stream of audio clips, such as: an author of the one of the audio clips, a date of creation or generation of the one of the audio clips, metadata characterizing the audio content in the one of the audio clips, etc.

Moreover, the generation of the temporal stream of audio clips may be dynamically adapted based on a user-selection history of the user (which includes one or more user selections prior to the user selection) and/or user selections made by other users. Thus, the temporal stream of audio clips may be modified based on the average user selections over a time interval (such as a day, three days, a week or a month) and/or the average user selections of a group of users who have similar characteristics or attributes (and, more generally, user profiles). In this way, variations in the dynamic modification may be smoothed or filtered out to avoid changes that, in fact, do not reflect the user's interests or wishes.

In some embodiments, electronic device 110 dynamically adapts the audio quality of the temporal stream of audio clips and/or the audio content based on one or more performance metrics that characterize the communication in FIG. 1. For example, if a performance metric indicates that the quality of the communication has degraded (as evidenced by the retry rate), electronic device 116-1 may reduce the audio sampling rate of the temporal stream of audio clips and/or the audio content.

Additionally, when listening to the temporal stream of audio clips, the user may have the option to purchase access to premium content (e.g., for a single use, multiple uses, a defined time period, such as a week, or purchase). For example, the user may need to consent to purchase access to one or more of the audio clips or the longer audio content, such as by activating a virtual icon in the user interface in electronic device 116-1.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

FIG. 2 presents embodiments of a flow diagram illustrating method 200 for providing a temporal stream of audio clips, which may be performed by an electronic device (such as electronic device 110 in FIG. 1). During operation, the electronic device receives an activation command (operation 210) from another electronic device associated with a user. Then, the electronic device generates, on an ongoing basis until one of information specifying a user selection and a deactivation command is received, the temporal stream of audio clips (operation 212), where a given audio clip includes a given temporal subset of audio content that is associated with the given audio clip, and the audio clips are arranged sequentially in the temporal stream. Note that the first temporal subset may include a snippet of the audio content that has a time duration that is a fraction of a time duration of the audio content. Moreover, note that memory in the electronic device may optionally store predefined user preferences of the user, and the electronic device may optionally generate the temporal stream of audio clips (operation 212) based on the predefined user preferences.

Furthermore, the electronic device provides, on the ongoing basis, the audio clips in the temporal stream of audio clips (operation 214) to the other electronic device.

Subsequently, the electronic device receives, from the other electronic device, the information specifying the user selection (operation 216) of one of the audio clips. In response to the user selection, the electronic device suspends the providing, to the other electronic device, of the temporal stream of audio clips (operation 218).

Next, the electronic device provides, to the other electronic device, audio content associated with the one of the audio clips (operation 220), where the audio content includes at least a second temporal subset of the audio content that is longer than a first temporal subset in the one of the audio clips, and the first temporal subset and the second temporal subset have approximately the same audio quality (such as the same sampling rate). In some embodiments, the electronic device optionally provide, concurrently with the audio content, video content (operation 222) associated with the one of the audio clips to the other electronic device.

Furthermore, the electronic device resumes the providing, to the other electronic device, of the audio clips in the temporal stream of audio clips (operation 228) when the audio content is completed (operation 224).

Additionally, prior to resuming the providing of the temporal stream of audio clips, the electronic device may optionally dynamically adapt the generation (operation 226) of the temporal stream of audio clips based on the user selection to modify subsequent audio clips in the temporal stream of audio clips. Furthermore, the generation of the temporal stream of audio clips may be dynamically adapted based on a user-selection history of the user (which includes one or more user selections prior to the user selection) and/or user selections made by other users (such as other users that have similar characteristics to the user and/or who have made similar user selections to those of the user).

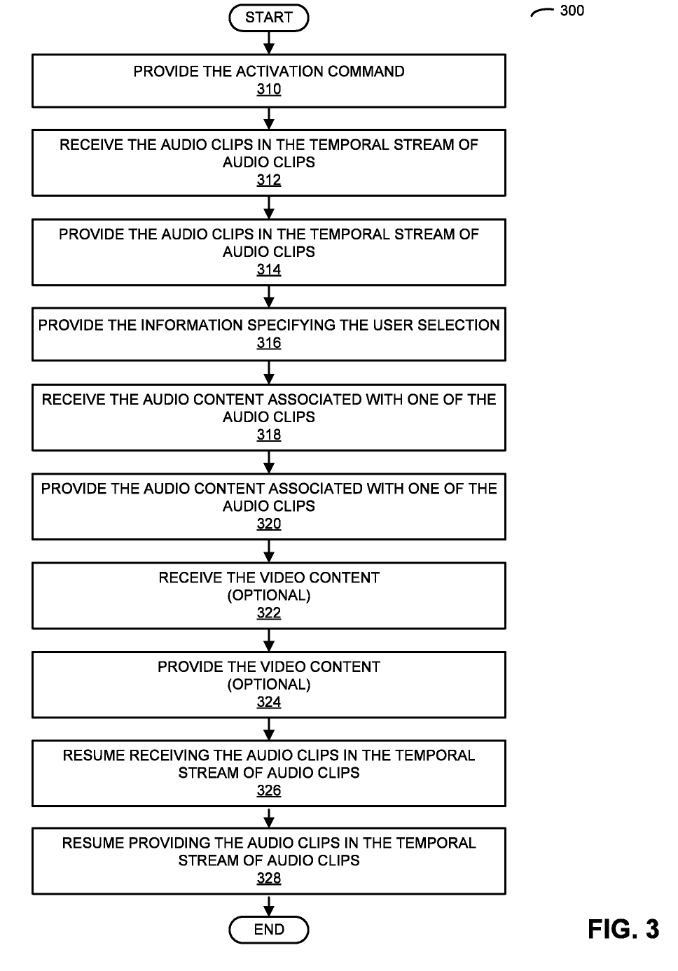

FIG. 3 presents embodiments of a flow diagram illustrating method 300 for receiving a temporal stream of audio clips, which may be performed by the other electronic device associated with the user (such as one of electronic devices 116 in FIG. 1). During operation, the other electronic device provides the activation command (operation 310) to the electronic device. Then, the other electronic device receives the audio clips in the temporal stream of audio clips (operation 312) from the electronic device. In response, the other electronic device provides the audio clips in the temporal stream of audio clips (operation 314) to the user. For example, the other electronic device may output sound associated with the temporal stream of audio clips on one or more speakers or on a headphone jack or output port.

Subsequently, the other electronic device provides, to the electronic device, the information specifying the user selection (operation 316) of the one of the audio clips. Next, the other electronic device receives, from the electronic device, the audio content associated with the one of the audio clips (operation 318), which the other electronic device provides (operation 320) to the user. In some embodiments, the other electronic device optionally receives, from the electronic device, the video content associated with the one of the audio clips (operation 322), which the other electronic device optionally provides (operation 324) to the user. For example, the other electronic device may present the video content on a display in the other electronic device.

After the audio content is completed, the other electronic device resumes receiving, from the electronic device, the audio clips in the temporal stream of audio clips (operation 326), which the other electronic device provides (operation 328) to the user.

In this way, the electronic devices (for example, an interface circuit, a driver and/or software executed in an environment, such as an operating system, of the electronic device or the other electronic device) may assist the user in identifying and accessing content (such as audio content and/or video content) that is of interest to the user. In particular, the user may be able to efficiently screen a large amount of audio content and/or video content. Moreover, the user may be able to screen the audio content while they are performing another task. For example, the user can listen to the temporal stream of audio clips in the ‘background’ while they are doing something else. If the user hears something that is of interest in a particular audio clip, the user may be able to select this audio clip to hear more detailed information about it. Consequently, the content-presentation technique may allow the user to be more productive, which may enhance the overall user experience.

In some embodiments of methods 200 (FIG. 2) and/or 300 (FIG. 3), there may be additional or fewer operations. Moreover, the order of the operations may be changed, and/or two or more operations may be combined into a single operation. For example, instead of generating the temporal stream of audio clips in operation 212 in FIG. 2, the electronic device may, at least initially, access a previously generated temporal stream of audio clips.

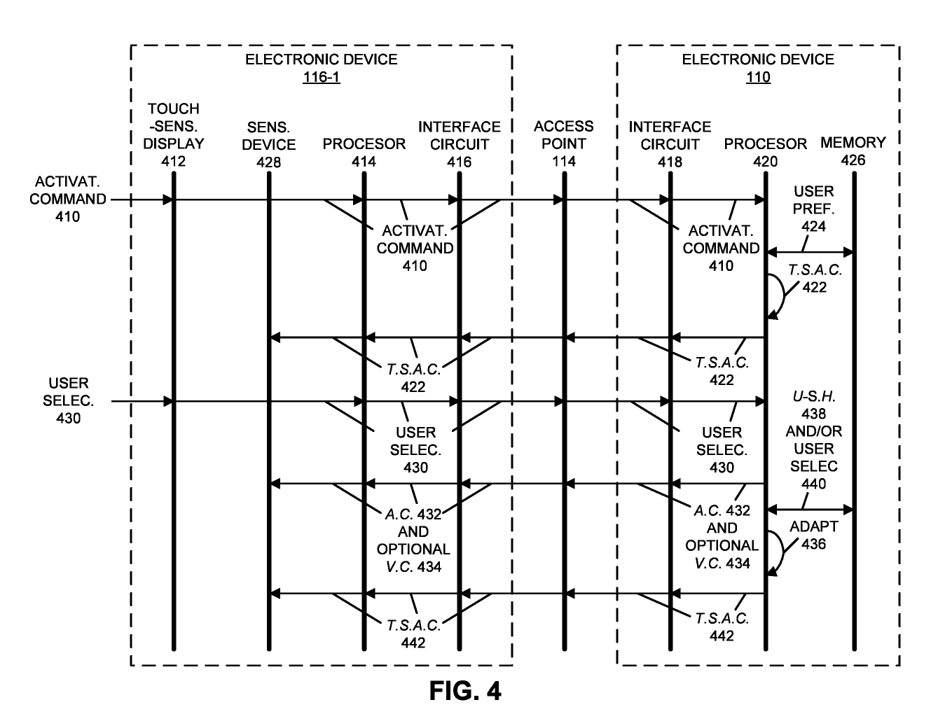

Embodiments of the content-presentation technique are further illustrated in FIG. 4, which presents a drawing illustrating communication among electronic device 110, access point 114 and electronic device 116-1 (FIG. 1). In particular, during the content-presentation technique, a user may provide activation command 410 (or information specifying activation command 410) to a touch-sensitive display 412 (e.g., by activating a virtual icon in a user interface), which may provide activation command 410 to processor 414 and then to interface circuit 416. Then, interface circuit 416 may provide activation command 410 to electronic device 110 via access point 114.

In response to receiving activation command 410, interface circuit 418 in electronic device 110 may provide activation command 410 to processor 420, which may generate temporal stream of audio clips (T.S.A.C.) 422. In some embodiments, processor 420 optionally accesses predefined user preferences 424 in memory 426, and processor 420 optionally generates temporal stream of audio clips 422 based on predefined user preferences 424. Then, interface circuit 418 may provide temporal stream of audio clips 422 to electronic device 116-1 via access point 114.

After receiving temporal stream of audio clips 422, interface circuit 416 may provide temporal stream of audio clips 422 to processor 414, which may provide temporal stream of audio clips 422 (or associated electrical signals) to sensory device 428 (such as one or more speakers) that output sound to the user.

Next, a user may provide user selection 430 (or information specifying user selection 430) of one of the audio clips to a touch-sensitive display 412, which may provide user selection 430 to processor 414 and then to interface circuit 416. Then, interface circuit 416 may provide user selection 430 to electronic device 110 via access point 114.

In response to receiving user selection 430, interface circuit 418 may provide user selection 430 to processor 420, which suspends providing temporal stream of audio clips 422 to electronic device 116-1. Instead, processor 420 may provide audio content (A.C.) 432 (such as a full or a completed audio file) and/or optional video content (V.C.) 434 associated with the one of the audio clips to interface circuit 418, which may provide audio content 432 and/or optional video content 434 to electronic device 116-1 via access point 114.

After receiving audio content 432 and/or optional video content 434, interface circuit 416 may provide audio content 432 and/or optional video content 434 to processor 414, which may provide audio content 432 and/or optional video content 434 (or associated electrical signals) to sensory device 428 that outputs sounds and/or provides images to the user.

When audio content 432 is completed, processor 420 may resume providing audio clips in the temporal stream of audio clips 442 to interface circuit 418, which may provide temporal stream of audio clips 442 to electronic device 116-1 via access point 114. Then, after receiving temporal stream of audio clips 442, interface circuit 416 may provide temporal stream of audio clips 442 to processor 414, which may provide temporal stream of audio clips 442 (or associated electrical signals) to sensory device 428 (such as one or more speakers) that output sound to the user.

In some embodiments, when audio content 432 is completed, processor 420 optionally dynamically adapts 436 the generation of temporal stream of audio clips 442 based on user selection 430 to modify subsequent audio clips in temporal stream of audio clips 442. Moreover, processor 420 may optionally access user-selection history (U-S.H.) 438 of the user and/or user selections 440 made by other users in memory 426, and processor 420 optionally generates temporal stream of audio clips 442 based on user-selection history 438 and/or user selections 440.

As noted previously, when the user provides a user selection of one of the audio clips, the temporal stream of audio clips may be interrupted or suspended and additional audio content for the one of the audio clips may be provided to the user. This is shown in FIGS. 5 and 6, which presents drawing illustrating a temporal stream of audio clips 510. At time 514, the user selection of audio clip 512-2 is received. In response, a longer temporal subset of audio content 516 is provided to the user. When the longer temporal subset of audio content 516 is completed at time 518, the providing of the audio clips in the temporal stream of audio clips 510 resumes either at a timestamp in audio clip 512-2 when the user selection was received (as shown in FIG. 5) or at a beginning of a subsequent audio clip 512-3 (as shown in FIG. 6).

While the preceding discussion uses a temporal stream of audio clips as an illustration, in other embodiments other types of content may be provided to a user in a continuous stream. For example, there may be a temporal stream of video clips or images (such as photographs), and when one of the video clips is selected by the user, a longer section of the video content associated with the video clip may be presented to the user. Similarly, in some embodiments a temporal stream of audio clips and associated video clips may be concurrently presented to the user.

Thus, the content-presentation technique may be used with a wide variety of different types of content (in a wide variety of formats) and/or combinations of different types of content, including: audio, video, images, music, songs, books, articles, presentations, emails, tweets (or written messages having a restricted maximum number of characters per message), voicemails, text messages, letters, notes, word-processing documents, spreadsheets, multimedia, etc. In the case of written content, a voice synthesizer may be used to automatically convert the text into sounds that can be provided to the user.

Note that images (such as identification logos) associated with the audio clips may be provided and presented on a display concurrently with the temporal stream of audio clips. Thus, may assist the user in identifying the audio clips that they want to select.

Furthermore, the temporal stream of content in the content-presentation technique may be unicast to a user or may be multicast to multiple users in a group. Then, if one of the users in the group provides the user selection, all the users in the group may receive the longer version of the content. This approach may allow the group of users to collaboratively identify content that is of interest.

In some embodiments, a ‘listening’ session for a user (such as one or more instances of audio content that the user selects while listening to the temporal stream of audio content) may be stored for subsequent use and/or may be provided to another user (e.g., based on an instruction or a command received from the user, or at a predefined time specified by the user). Alternatively or additionally, a user-listening session may be automatically posted to a user account in a social network or to another web page (or website) as a compressed or an uncompressed audio file (such a shared user-listening session is sometimes referred to as a ‘shared unit’ or a ‘shared segment’). Note that a user-listening session may be automatically converted to text prior to posting to the user account in the social network or the other web page (or website). Moreover, a user-listening session may include metadata, which may allow a file with the user-listening session to be searchable (e.g., using a search engine). Thus, the content-presentation technique may make the audio content browsable.

Additionally, the content-presentation technique may recommend audio clips in a temporal stream of audio clips that may be of interest to the user, such as based on the predefined user preferences, the history of user selections by the user and/or user selections by other users. For example, a sound, an image and, more generally, a sensory stimulus may be used to alert the user that a particular audio clip may be of interest.

We now describe embodiments of the electronic device. FIG. 7 presents a block diagram illustrating an electronic device 700, such as electronic device 110 (FIG. 1), access point 114 (FIG. 1) or one of electronic devices 116 in FIG. 1 (e.g., electronic device 116-1). This electronic device includes processing subsystem 710, memory subsystem 712, and networking subsystem 714. Processing subsystem 710 includes one or more devices configured to perform computational operations. For example, processing subsystem 710 can include one or more microprocessors, application-specific integrated circuits (ASICs), microcontrollers, programmable-logic devices, and/or one or more digital signal processors (DSPs).

Memory subsystem 712 includes one or more devices for storing data and/or instructions for processing subsystem 710 and networking subsystem 714. For example, memory subsystem 712 can include dynamic random access memory (DRAM), static random access memory (SRAM), and/or other types of memory. In some embodiments, instructions for processing subsystem 710 in memory subsystem 712 include: one or more program modules or sets of instructions (such as program module 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718, one or more antennas 720 and/or input/output (I/O) port 730. (While FIG. 7 includes one or more antennas 720, in some embodiments electronic device 700 includes one or more nodes 708, e.g., a pad, which can be coupled to one or more antennas 720. Thus, electronic device 700 may or may not include one or more antennas 720.) For example, networking subsystem 714 can include a Bluetooth networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 700 may use the mechanisms in networking subsystem 714 for performing simple wireless communication between the electronic devices, e.g., transmitting advertising or beacon frames and/or scanning for advertising frames transmitted by other electronic devices as described previously.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc. Moreover, electronic device 700 may include an audio subsystem 732 for outputting sound on one or more speakers or to a headphone jack.

Electronic device 700 can be (or can be included in) any electronic device with at least one network interface. For example, electronic device 700 can be (or can be included in): a desktop computer, a laptop computer, a subnotebook/netbook, a server, a tablet computer, a smartphone, a cellular telephone, a smart watch, a consumer-electronic device, a portable computing device, an access point, a router, a switch, communication equipment, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, display subsystems and/or audio subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments, some or all of a given subsystem or component can be integrated into one or more of the other subsystems or component(s) in electronic device 700. For example, in some embodiments program module 722 is included in operating system 724.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 714, such as a radio. Moreover, the integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, receiving the temporal stream of audio clips, etc.)

While communication protocols compatible with Ethernet and Wi-Fi were used as illustrative examples, the described embodiments of the content-presentation technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the content-presentation technique may be implemented using program module 722, operating system 724 (such as a driver for interface circuit 718) and/or in firmware in interface circuit 718. Alternatively or additionally, at least some of the operations in the content-presentation technique may be implemented in a physical layer, such as hardware in interface circuit 718.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the communication technique. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with another electronic device via a network;
a processor; and
memory, coupled to the processor, storing instructions that, when executed by the processor, cause the electronic device to:
receive an activation command from the other electronic device associated with a user;
generate, on an ongoing basis until one of information specifying a user selection and a deactivation command is received, a temporal stream of audio clips, wherein a given audio clip includes a given temporal subset of audio content that is associated with the given audio clip, and wherein the audio clips are arranged sequentially in the temporal stream;
provide, on the ongoing basis, the audio clips in the temporal stream of audio clips to the other electronic device;
receive, from the other electronic device, the information specifying the user selection of one of the audio clips;
suspend the providing, to the other electronic device, of the temporal stream of audio clips in response to the user selection;
provide, to the other electronic device, audio content associated with the one of the audio clips, wherein the audio content includes at least a second temporal subset of the audio content that is longer than a first temporal subset in the one of the audio clips, and wherein the first temporal subset and the second temporal subset have approximately the same audio quality; and
resume the providing, to the other electronic device, of the audio clips in the temporal stream of audio clips when the audio content is completed.

2. The electronic device of claim 1, wherein the temporal stream of audio clips resumes at a timestamp when the user selection was made.

3. The electronic device of claim 1, wherein the temporal stream of audio clips resumes at a beginning of a subsequent audio clip in the temporal stream of audio clips after the one of the audio clips.

4. The electronic device of claim 1, wherein the memory further stores instructions that, when executed by the processor, cause the electronic device to provide, concurrently with the audio content, video content associated with the one of the audio clips to the other electronic device.

5. The electronic device of claim 1, the memory further stores instructions that, when executed by the processor, cause the electronic device to, prior to resuming the providing of the temporal stream of audio clips, dynamically adapt the generation of the temporal stream of audio clips based on the user selection to modify subsequent audio clips in the temporal stream of audio clips.

6. The electronic device of claim 5, wherein the generation of the temporal stream of audio clips is further dynamically adapted based on a user-selection history of the user, which includes one or more user selections prior to the user selection.

7. The electronic device of claim 5, wherein the generation of the temporal stream of audio clips is further dynamically adapted based on user selections made by other users.

8. The electronic device of claim 1, wherein the first temporal subset includes a snippet of the audio content that has a time duration that is a fraction of a time duration of the audio content.

9. A computer-program product for use in conjunction with an electronic device, the computer-program product comprising a non-transitory computer-readable storage medium and instructions embedded therein, which when executed by a processor cause the electronic device to:
receive an activation command from another electronic device associated with a user;
generate, on an ongoing basis until one of information specifying a user selection and a deactivation command is received, the temporal stream of audio clips, wherein a given audio clip includes a given temporal subset of audio content that is associated with the given audio clip, and wherein the audio clips are arranged sequentially in the temporal stream;
provide, on the ongoing basis, the audio clips in the temporal stream of audio clips to the other electronic device;
receive, from the other electronic device, the information specifying the user selection of one of the audio clips;
suspend the providing, to the other electronic device, of the temporal stream of audio clips in response to the user selection;
provide, to the other electronic device, audio content associated with the one of the audio clips, wherein the audio content includes at least a second temporal subset of the audio content that is longer than a first temporal subset in the one of the audio clips, and wherein the first temporal subset and the second temporal subset have approximately the same audio quality; and
resume the providing, to the other electronic device, of the audio clips in the temporal stream of audio clips when the audio content is completed.

10. The computer-program product of claim 9, wherein the temporal stream of audio clips resumes at a timestamp when the user selection was made.

11. The computer-program product of claim 9, wherein the temporal stream of audio clips resumes at a beginning of a subsequent audio clip in the temporal stream of audio clips after the one of the audio clips.

12. The computer-program product of claim 9, wherein, when executed by the processor, the instructions further cause the electronic device to provide, concurrently with the audio content, video content associated with the one of the audio clips to the other electronic device.

13. The computer-program product of claim 9, wherein, when executed by the processor, the instructions further cause the electronic device to, prior to resuming the providing of the temporal stream of audio clips, dynamically adapt the generation of the temporal stream of audio clips based on the user selection to modify subsequent audio clips in the temporal stream of audio clips.

14. The computer-program product of claim 13, wherein the generation of the temporal stream of audio clips is further dynamically adapted based on a user-selection history of the user, which includes one or more user selections prior to the user selection.

15. The computer-program product of claim 13, wherein the generation of the temporal stream of audio clips is further dynamically adapted based on user selections made by other users.

16. The computer-program product of claim 9, wherein the first temporal subset includes a snippet of the audio content that has a time duration that is a fraction of a time duration of the audio content.

17. An electronic-device-implemented method for providing a temporal stream of audio clips, wherein the method comprises:
receiving an activation command from another electronic device associated with a user;
generating, on an ongoing basis until one of information specifying a user selection and a deactivation command is received, the temporal stream of audio clips, wherein a given audio clip includes a given temporal subset of audio content that is associated with the given audio clip, and wherein the audio clips are arranged sequentially in the temporal stream;
providing, on the ongoing basis, the audio clips in the temporal stream of audio clips to the other electronic device;
receiving, from the other electronic device, the information specifying the user selection of one of the audio clips;
suspending the providing, to the other electronic device, of the temporal stream of audio clips in response to the user selection;
providing, to the other electronic device, audio content associated with the one of the audio clips, wherein the audio content includes at least a second temporal subset of the audio content that is longer than a first temporal subset in the one of the audio clips, and wherein the first temporal subset and the second temporal subset have approximately the same audio quality; and
resuming the providing, to the other electronic device, of the audio clips in the temporal stream of audio clips when the audio content is completed.

18. The method of claim 17, wherein the temporal stream of audio clips resumes at one of: a timestamp when the user selection was made; and a beginning of a subsequent audio clip in the temporal stream of audio clips after the one of the audio clips.

19. The method of claim 17, wherein the method further comprises, prior to the resuming the providing of the temporal stream of audio clips, dynamically adapting the generation of the temporal stream of audio clips based on the user selection to modify subsequent audio clips in the temporal stream of audio clips.

20. The method of claim 17, wherein the first temporal subset includes a snippet of the audio content that has a time duration that is a fraction of a time duration of the audio content.
